(19) United States
(12) Patent Application Publication
(10) Pub. No.: US 2023/0258522 A1
(43) Pub. Date: Aug. 17, 2023

(54) INPUT DEVICE CALIBRATIONS

(71) Applicant: HEWLETT-PACKARD DEVELOPMENT COMPANY, L.P., Spring, TX (US)

(72) Inventors: Hung Sung Pan, Taipei City (TW); Yi Yun Chang, Taipei City (TW); Chen Jie Wu, Taipei City (TW)

(73) Assignee: HEWLETT-PACKARD DEVELOPMENT COMPANY, L.P., Spring, TX (US)

(21) Appl. No.: 17/670,640

(22) Filed: Feb. 14, 2022

(51) Int. Cl. G01L 27/00; G06F 3/01; G06F 3/041; G01L 1/14; G01G 9/00

(52) U.S. Cl. CPC G01L 27/002; G06F 3/016; G06F 3/0414; G01L 1/14; G01G 9/00

(57) ABSTRACT

In one example in accordance with the present disclosure, an electronic device is described. The example electronic device includes an input device with a force sensor to measure a force applied to the input device. The example electronic device also includes a controller to receive a user selection of an object type for an object to be placed on a location of the input device. The controller is to determine a weight of the object in response to receiving the user selection. The controller is to also receive a force measurement from the force sensor in response to placement of the object on the input device. The controller is to calibrate the force sensor based on the object weight and the force measurement.

### BACKGROUND

Electronic technology has advanced to become virtually ubiquitous in society and has been used to enhance many activities in society. For example, electronic devices are used to perform a variety of tasks, including work activities, communication, research, and entertainment. Different varieties of electronic circuits may be utilized to provide different varieties of electronic technology.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an electronic device to perform input device calibrations, according to an example.

FIG. 2 illustrates components of a touchpad, according to an example.

FIG. 3 illustrates object placement on the input device, according to an example.

FIG. 4 illustrates a graph depicting a force-displacement curve, according to an example.

FIG. 5 is a flow diagram illustrating a method for input device calibration, according to an example.

FIG. 6 is a flow diagram illustrating another method for input device calibration, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

An electronic device is a device that includes electronic circuitry. For instance, an electronic device may include integrated circuitry (e.g., transistors, digital logic, semiconductor technology, etc.). Examples of electronic devices include computing devices, laptop computers, desktop computers, smartphones, tablet devices, graphic tablets, multi-touch devices, wireless communication devices, game consoles, smart appliances, vehicles with electronic components, aircraft, drones, robots, smart appliances, etc.

In some examples, an electronic device may include an input device. A user may use the input device to provide information (e.g., user input) to the electronic device. In some examples, the input device may allow the user to provide user input through touching the input device. Some examples of an input device include touchpads, trackpads, haptic pads, touchscreens, etc.

The input device may include a touch surface (referred to herein as a cover) that a force may contact. For example, a user may apply a force (e.g., with a finger, stylus, pointer, etc.) to the touch surface. The input device may include a touch sensor to detect when a force contacts the touch surface. In some examples, the touch sensor may also determine the location on the touchpad where the contact occurs.

The input device may include a force sensor to measure the force applied to the input device. For example, the force sensor may detect an amount of displacement of the input device. The force sensor may provide the force measurement to a controller or other circuitry in the electronic device. The electronic device may perform an operation based on the force measurement. For example, the electronic device may provide haptic feedback to a user when the force measurement is equal to or greater than a force threshold.

The accuracy of the force sensor may change over time. For example, the force sensor may have an initial calibration when the electronic device is manufactured. Environmental changes may result in a loss of accuracy of the force sensor. In some examples, the accuracy of the force sensor may change through usage over time. In some examples, the accuracy of the force sensor may change due to a shock (e.g., impact, physical drop, vibration, etc.) to the electronic device. In some examples, parts of the input device (e.g., the touch surface, touch sensor, a bracket supporting the force sensor, etc.) may become deformed, which changes the measurements of the force sensor.

Lower force sensor accuracy may result in an uneven experience when using the input device. For example, the force sensor may detect a force with a first magnitude in a first region of the input device and a second magnitude for the same force in a second region of the input device. In an example of haptic feedback, a user may have to press much harder in one region than another region of the input device to trigger the haptic feedback. As seen by this discussion, an inaccurate force sensor may result in poor user experience.

This specification discloses input device calibrations. In some examples, the present specification describes an electronic device that includes an input device with a force sensor to measure a force applied to the input device. The example electronic device also includes a controller to receive a user selection of an object type for an object to be placed on a location of the input device. The controller is to determine a weight of the object in response to receiving the user selection. The controller is to also receive a force measurement from the force sensor in response to placement of the object on the input device. The controller is to calibrate the force sensor based on the object weight and the force measurement.

In another example, the present specification also describes an electronic device that includes a touchpad with a force sensor to measure displacement of the touchpad in response to a force applied to the touchpad. The example electronic device also includes a memory to store a weight of an object. The example electronic device further includes a controller to generate a user instruction to place the object on a location of the touchpad. The controller also receives a measured displacement of the touchpad from the force sensor in response to placement of the object on the touchpad. The controller further calibrates the force sensor based on the stored weight and the measured displacement.

In yet another example, the present specification also describes an electronic device that includes a touchpad with a force sensor to measure displacement of the touchpad in response to a force applied to the touchpad. The electronic device also includes a controller to generate a first user instruction to place a first object on the touchpad. The controller receives a first measured displacement of the touchpad from the force sensor in response to placement of the first object on the touchpad. The controller generates a second user instruction to place the first object and a second object on the touchpad. The controller receives a second measured displacement of the touchpad from the force sensor in response to placement of the first object and the second object on the touchpad. The controller determines a force-displacement curve for the force sensor based on the first measured displacement and the second measured displacement.

As used in the present specification and in the appended claims, the term, “controller” may be a processor, an application-specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer-usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the respective component, cause the component to implement the functionality described herein.

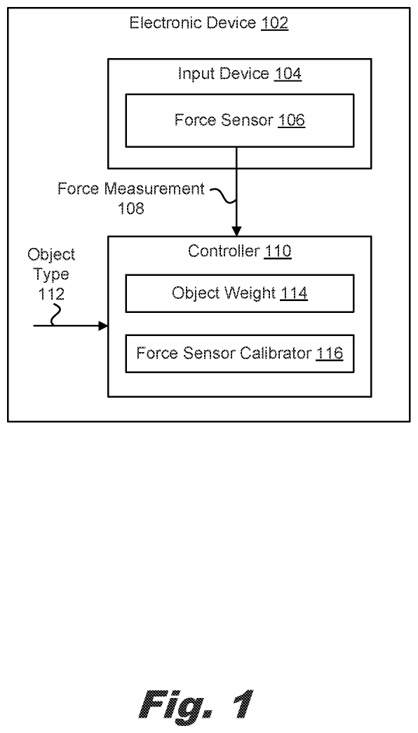

Turning now to the figures, FIG. 1 is a block diagram of an electronic device 102 to perform input device calibrations, according to an example. Examples of the electronic device 102 include computing devices, laptop computers, desktop computers, smartphones, tablet devices, graphic tablets, multi-touch devices, wireless communication devices, game consoles, smart appliances, vehicles with electronic components, aircraft, drones, robots, smart appliances, etc.

In some examples, the electronic device 102 includes an input device 104. The input device 104 facilitates interaction by a user with the electronic device 102. Examples of the input device 104 include Some examples of the input device 104 include a touchpad, trackpad, haptic pad, touchscreen, etc. For example, the input device 104 may be a touchpad on a laptop computer. In another example, the input device 104 may be a touchscreen of a tablet device (e.g., smartphone).

The input device 104 may include a force sensor 106 to measure a force applied to the input device 104. For example, when a user presses their finger on the input device 104, the force sensor 106 may measure the amount of force exerted by the finger on the input device 104. The force sensor 106 outputs a force measurement 108, which is a signal indicating the amount of force applied to the input device 104.

In some examples, the force sensor 106 measures the displacement of the input device 104. In the example of a touchpad, the force sensor 106 may measure the magnitude of displacement of the touchpad. In this example, the force measurement 108 is measured displacement of the touchpad.

In some examples, the force sensor 106 may use capacitive force sensing to measure touchpad displacement. For example, the force sensor 106 may include a touch sensor (e.g., a printed circuit board (PCB) touch sensor) and a force plate. A gap may exist between the force plate and the touch sensor. When a user presses the touchpad, the gap between the touch sensor and the force plate may reduce, which results in an increase in a capacitive value. In this case, the capacitive value is the displacement measurement. The capacitive value may be transferred to a force value.

The force sensor 106 may output the force measurement 108 in the form of a signal that indicates the measured displacement of the touchpad. In some examples, the force sensor 106 may output the force measurement 108 as a change in capacitive value. As described herein, a capacitive value may be mapped to a given force exerted on the touchpad. Using the capacitive value-to-force mapping, subsequent forces may be determined from the capacitive value output by the force sensor 106. It should be noted that capacitive sensing is one example of measuring the displacement of a touchpad. In some examples, other sensing technologies may be used to measure the touchpad displacement.

The electronic device 102 includes a controller 110. In some examples, the controller 110 may be a CPU of the electronic device 102 that executes an operating system (OS) for the electronic device 102. In some examples, the controller 110 may be separate from the processor that executes the OS. For example, the controller 110 may be an ASIC, a semiconductor-based microprocessor, an FPGA, other hardware device that communicates with the input device 104. In some examples, the controller 110 may be integrated with the input device 104.

The controller 110 may receive the force measurement 108 from the force sensor 106. For example, when a force is applied to the input device 104, the force sensor 106 may output the force measurement 108 to the controller 110. The controller 110 may process the force measurement 108 to determine a value of the force exerted on the input device 104. For example, in the case that the force sensor 106 outputs a displacement measurement, the controller 110 may correlate the displacement measurement to a magnitude of force. In some examples, the controller 110 may use a force-displacement curve that translates a displacement measurement to a force. For example, upon receiving the force measurement 108 that indicates a measured displacement, the controller 110 may convert the displacement measurement using the force-displacement curve.

As discussed above, the force sensor 106 may become less accurate over time. For example, physical impacts on the electronic device 102 may deform force sensor components. The force sensor deformations may result in inaccurate force measurements 108 by the force sensor 106. In some examples, the force sensor inaccuracies may occur in a first region of the input device 104 while a second region of the input device 104 may remain accurate. In some examples, the force sensor inaccuracies may be present throughout multiple regions of the input device 104.

To address changes in the force sensor 106, the controller 110 may perform calibration of the force sensor 106. The input device calibration may reset the force sensor 106 to account for changes to the force sensor 106 or other components of the electronic device 102.

In some examples, the controller 110 may communicate with a user through a user interface (e.g., a graphical user interface presented on a display device). The controller 110 may issue instructions that are presented on the user interface. The controller 110 may receive responses from the user.

In some examples, the controller 110 may receive a user selection of an object type 112 for an object to be placed on a location of the input device 104. For example, the controller 110 may generate a user instruction to select the object type 112. The user instruction may be presented on the user interface. The user may then select the object type 112 through the user interface.

The object may be an item that is small enough to be placed on the input device 104. In the example of a touchpad, the object may fit within the borders of the touchpad surface.

In some examples, the object may be an item that has given properties that are determined by the object type 112. In some examples, the object may be a coin (e.g., a US quarter, a 1 euro, a New Taiwan $50, etc.). In some examples, the coin may be local to a region (e.g., geographic area) in which the electronic device 102 is used. For example, if the electronic device 102 is being used in the United States, the coin may be a US quarter. In the case that the object is a coin, the object type 112 may indicate the type of coin. For example, the user may select a US quarter from a list of coin options (e.g., US penny, nickel, dime, quarter, etc.).

Other examples of the object include calibration weights for calibrating scales. In this case, the object type 112 may indicate the size (e.g., weight) of the calibration weight. It should be noted that other types of objects may be used to calibrate the force sensor 106.

The controller 110 may determine the weight of the object in response to receiving the user selection. For example, the controller 110 may determine the object weight 114 based on the object type 112. In this example, the object type 112 received in the user selection indicates the weight of the object that is to be placed on the input device 104. In the case that the object is a coin, the coin may have a standardized weight. For example, a US quarter has a standardized weight of 5.6 grams, a 1 euro coin has a standardized weight of 7.5 grams, an NT $50 coin has a standardized weight of 10 grams, etc. By knowing what type of coin is being used, the controller 110 may determine the weight of the object.

In some examples, the electronic device 102 may store the weights of the object type 112 in memory (not shown). For example, an object weight database may be stored in the memory of the electronic device 102. Thus, the controller 110 may determine the object weight 114 from the object weight database based on the object type 112. The controller 110 may reference the object weight database to determine the stored weight of the selected object type 112. In some examples, the stored weight may be a standardized weight for a coin. In an example, if the selected object type 112 is a US quarter, then the controller 110 may determine, from the object weight database, that the object weight 114 is 5.6 grams.

In some examples, the controller 110 may obtain the object weight 114 from an object weight database that is external to the electronic device 102. For example, the electronic device 102 may be connected to a network (e.g., the internet). The controller 110 may send a request for the object weight 114 to another device on the network.

The controller 110 may receive a force measurement 108 from the force sensor 106 in response to placement of the object on the input device 104. In some examples, the controller 110 may generate a user instruction to place the object on a location of the input device 104 in response to receiving the user selection of the object type 112. For example, the user instruction may be an instruction for the user to place the object on a corner of the touchpad. The user may place the object on the input device 104 as instructed. The force sensor 106 may output the force measurement 108 to the controller 110.

In some examples, the controller 110 may receive the force measurement 108 as a measured displacement of the input device 104 in response to placement of the object on the input device 104. For example, the user may place a coin on the input device 104. The weight of the coin may cause the input device 104 to deflect. The force sensor 106 may detect the displacement of the input device 104 and may output the force measurement 108 indicating the measured displacement.

The controller 110 may implement a force sensor calibrator 116. In some examples, the force sensor calibrator 116 includes executable instructions that cause the controller 110 to calibrate the force sensor 106 based on the object weight 114 and the force measurement 108. In some examples, the object weight 114 is the stored object weight (e.g., the weight of the object stored in memory). In some examples, the force measurement 108 is the measured displacement.

The controller 110 may calibrate the force sensor 106 by determining a force-displacement curve based on the object weight 114 and the measured displacement. The force-displacement curve may relate the measured displacement to a force exerted on the input device 104. By knowing the object weight 114 (e.g., the weight of a coin), then the controller 110 may relate the displacement measured by the force sensor 106 to the object weight 114. The controller 110 may store the force-displacement curve in memory for use by the force sensor to determine a subsequent force applied to the input device 104. For example, the calibrated force-displacement curve may replace an existing force-displacement curve used to convert the displacement measure by the force sensor 106 to a force.

In some examples, the controller 110 may obtain multiple force measurements 108 to calibrate the force sensor 106. In an example, the controller 110 may receive multiple force measurements 108 for different amounts of objects placed at the same location of the input device 104. In an example, the controller 110 may generate a first user instruction to place a first object (e.g., a US quarter coin) on the input device 104. The controller 110 may receive a first measured displacement of the input device 104 from the force sensor 106 in response to placement of the first object on the input device 104.

The controller 110 may generate a second user instruction to place the first object and a second object (e.g., a second US quarter coin) on the input device 104. In some examples, the first object and the second object are of a same object type (e.g., both coins of the same denomination). In some examples, the first object and the second object may be stacked such that their combined weight is applied to the same location of the input device 104. The controller 110 may receive a second measured displacement of the input device 104 from the force sensor 106 in response to placement of the first object and the second object on the input device 104.

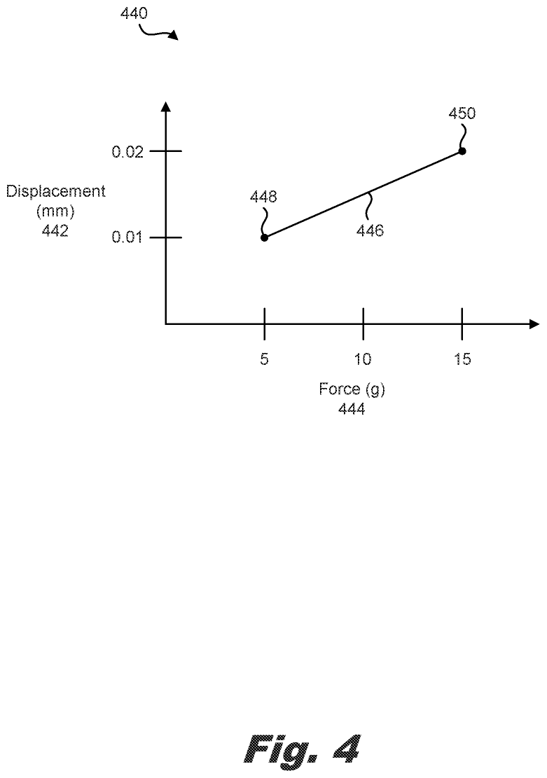

The controller 110 may determine a force-displacement curve for the force sensor 106 based on the first measured displacement and the second measured displacement. The controller 110 may determine the force-displacement curve based further on the weight 114 of the object type 112. For example, if the first object and the second object are the same object type 112 (e.g., a US quarter coin), then the controller 110 may use the stored object weight 114 for that object type 112 for both the first object and the second object. The force-displacement curve indicates an amount of force applied to the input device 104 based on the measured displacement of the input device 104. An example of the controller 110 determining a force-displacement curve from multiple displacement measurements is described in FIG. 4. It should be noted that while this example describes calibration with two objects, in other examples a different number of objects (e.g., 3, 4, 5, etc.) may be used to calibrate the force sensor 106.

In some examples, the controller 110 is to determine a plurality of force-displacement curves for a plurality of locations on the input device 104. In the example where the input device 104 is a touchpad, the surface of the touchpad may be defined by multiple regions. For example, the touchpad surface may be four quadrants. The controller 110 may determine a first force-displacement curve for a first region of the input device 104, a second force-displacement curve for a second region, and so forth. This may be accomplished by the controller 110 instructing the user to place the object (or multiple objects) in multiple locations of the input device 104.

Upon determining the plurality of force-displacement curves, the controller 110 may select a given force-displacement curve for the force sensor based on a given location of the force on the touchpad. For example, if a force is detected in the first region, then the controller 110 may apply the first force-displacement curve to determine the force as measured by the force sensor 106. If a second force is detected in the second region, then the controller 110 may apply the second force-displacement curve to determine the second force as measured by the force sensor 106, and so forth.

In some examples, the input device 104 may provide haptic feedback. For example, the input device 104 may be a haptic pad that includes an actuator to provide haptic feedback in response to the force applied to the input device 104 exceeding a force threshold. The actuator may cause the input device 104 or other component of the electronic device 102 to move or provide other physical sensory feedback to the user. The actuator may be triggered when the force measured by the force sensor 106 meets or exceeds the force threshold. The controller 110 may calibrate the force threshold based on the object weight 114 and the force measurement 108 as described herein. For example, the controller 110 may apply a force-displacement curve determined from the object weight 114 and the force measurement 108 to determine whether a force on the input device 104 exceeds the force threshold. If the force-displacement curve indicates that the force on the input device 104 exceeds the force threshold, then the controller 110 may cause the actuator to provide haptic feedback. In some examples, the haptic feedback may be in the form of a click sensation provided to the user.

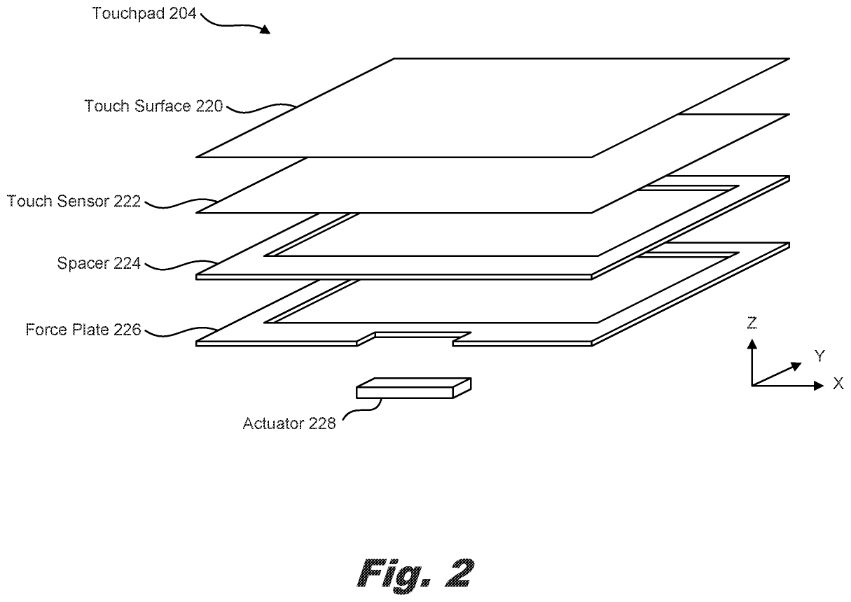

FIG. 2 illustrates components of a touchpad 204, according to an example. In this example, the components of the touchpad 204 are depicted in an exploded view. The touchpad 204 includes a touch surface 220 to interact with a user. The touchpad 204 includes a touch sensor 222. In some examples, the touch sensor 222 is a printed circuit board (PCB) that detects the location of a force on the touch surface 220 along the X-axis and Y-axis. In some examples, the touch sensor 222 may perform capacitive sensing to determine the location of the force on the touch surface 220.

In some examples, a spacer 224 may separate a force plate 226 from the touch sensor 222. The force plate 226 may be used to detect displacement of the touch surface 220 along a Z-axis in response to an applied force. The spacer 224 may create a gap between the force plate 226 and the touch sensor 222. When a user presses the touchpad 204, the gap between the touch sensor 222 and the force plate 226 may reduce, which results in an increase in a capacitive value (e.g., as measured by a capacitive sensor). In this case, the capacitive value is the displacement measurement. The capacitive value may be transferred to a force value.

In some examples, the touchpad 204 includes an actuator 228 to provide haptic feedback. For example, the actuator 228 may cause the touchpad to move along the Z-axis to simulate a click of the touchpad 204 to a user.

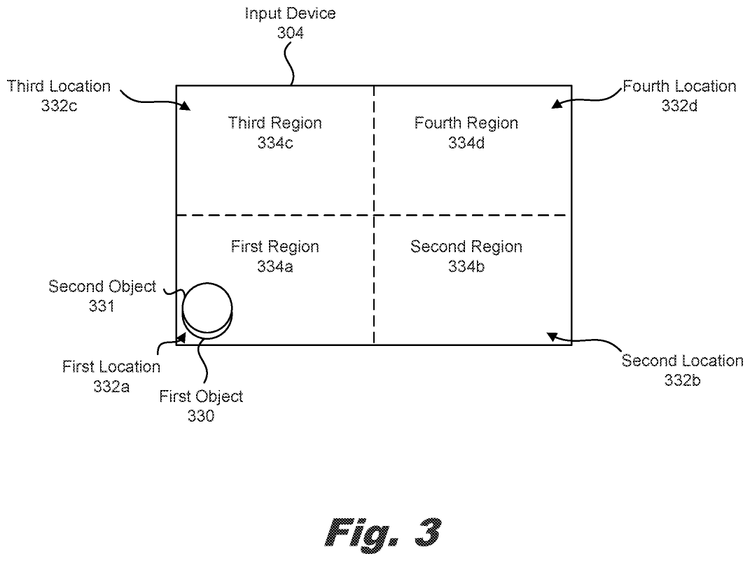

FIG. 3 illustrates object 330 placement on the input device 304, according to an example. In this example, the input device 304 is a touchpad. An object (e.g., a coin) is shown placed at a first location 332a. For example, a controller (FIG. 1, 110) may instruct a user to place the object in the first location 332a. The first location 332a may be corner of the input device 304. The controller may determine a force-displacement curve for the first location 332a, as described in FIG. 1. It should be noted that a second object 331 (e.g., a second coin) may be stacked on first object 330 at the first location 332a to obtain multiple displacement measurements at the first location 332a using multiple objects of a given weight.

In some examples, the controller may instruct the user to place an object (e.g., first object 330, the second object 331, etc.) in a second location 332b. The controller may determine a force-displacement curve for the second location 332b, as described in FIG. 1. This process may be repeated for the third location 332c and fourth location 332d.

The input device 304 may be defined by four regions (e.g., a first region 334a, a second region 334b, a third region 334c, and a fourth region 334d). Upon determining the four force-displacement curves for the four different locations 332a-d, the controller may apply a given force-displacement curve for a force in a given region. For example, if the controller determines that the force is applied to the first region 334a, then the controller may select the first force-displacement curve determined for the first location 332a. If the controller determines that the force is applied to the second region 334b, then the controller may select the first force-displacement curve determined for the second location 332b, and so forth. It should be noted that in other examples, the input device 304 may be divided into different regions than those described in this example.

FIG. 4 illustrates a graph 440 depicting a force-displacement curve 446, according to an example. In the graph 440, displacement 442 of the input device (e.g., FIG. 3, 304) is plotted in the Y-axis and the force 444 (e.g., weight) applied to the input device is plotted in the X-axis.

For a first point 448, a single object (e.g., FIG. 3, 330) is placed on an input device (e.g., FIG. 3, 304). The force sensor (e.g., FIG. 1, 106) may output a first displacement of the input device due to the weight of the single object. In this case, the object may be a coin with a weight of 5.6 grams, which causes a displacement of 0.01 mm, as plotted at a first point 448.

For a second point 450, a stack of 3 objects (e.g., 3 coins) is placed at the same location of the input device. The force sensor measures a displacement of 0.02 mm. Because the objects are the same object type, the controller multiplies the object weight of 5.6 grams by 3 to obtain a combined weight of 16.8 grams.

The force-displacement curve 446 is generated as a line connecting the first point 448 and the second point 450. In this example, the force-displacement curve 446. In other examples with three or more measurements using different numbers of objects, the force-displacement curve 446 may be defined as a polynomial curve.

In some examples, the controller may extrapolate the force-displacement curve 446 to determine a force 444 based on a measured displacement 442. For example, a measured displacement may be greater than the maximum displacement used to determine the force-displacement curve 446. The controller may perform an extrapolation (e.g., linear extrapolation) to determine the force 444 associated with the measured displacement.

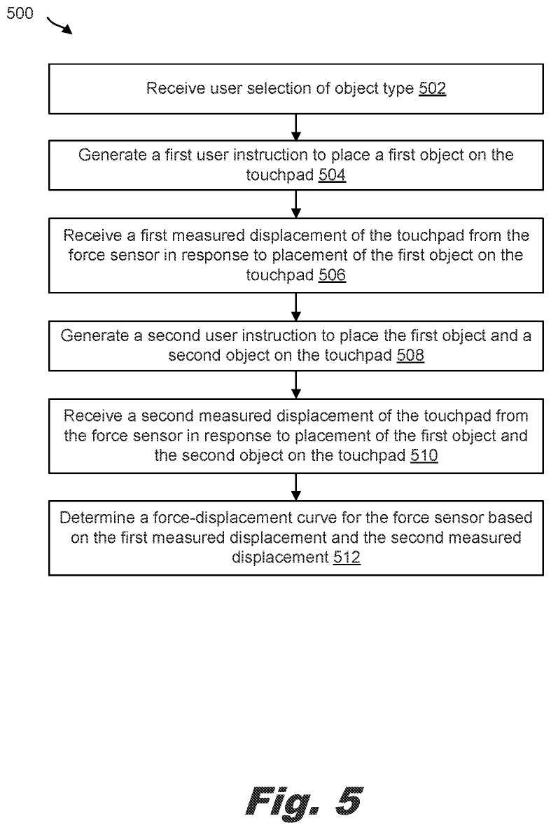

FIG. 5 is a flow diagram illustrating a method 500 for input device calibration, according to an example. The method 500 may be implemented by a controller 110 of an electronic device 102. In this example, the input device is a touchpad.

At 502, the controller 110 receives a user selection of an object type 112. For example, the controller 110 may generate a user instruction to select the object type 112 for use in calibrating the force sensor 106 of the touchpad. In some examples, the object may be a coin that is local to the region in which the electronic device 102 is used. The user selection may indicate that the object type 112 is a type of coin (e.g., a US quarter). The controller 110 may determine the weight of the object based on the selected object type 112. For example, the controller 110 may determine the standardized weight of the coin based on the selected object type 112.

At 504, the controller 110 generates a first user instruction to place a first object on the touchpad. In some examples, the first user instruction may indicate a location on the touchpad that the user is to place the object. The location may be a corner of the touchpad. In some examples, the first user instruction may instruct the user to place a coin of the selected object type 112 on the touchpad.

At 506, the controller 110 receives a first measured displacement of the touchpad from the force sensor 106 in response to placement of the first object on the touchpad. For example, the user may place the first object on the touchpad. The force sensor 106 may output the first measured displacement of the touchpad.

At 508, the controller generates a second user instruction to place the first object and a second object on the touch pad. The first object and the second object may be the same object type. For example, the first object and the second object may be the same type of coin. The second user instruction may instruct the user to place the first object and the second object in the same location.

At 510, the controller 110 receives a second measured displacement of the touchpad from the force sensor 106 in response to placement of the first object and the second object on the touchpad. For example, the user may stack the first object and the second object on the touchpad. The force sensor 106 may output the second measured displacement of the touchpad.

At 512, the controller 110 determines a force-displacement curve for the force sensor 106 based on the first measured displacement and the second measured displacement. For example, using the object weight 114 of the object type 112 (e.g., the weight of the coin type), the controller 110 may generate a force-displacement curve using the first measured displacement and the second measured displacement. This may be accomplished as described in FIG. 4.

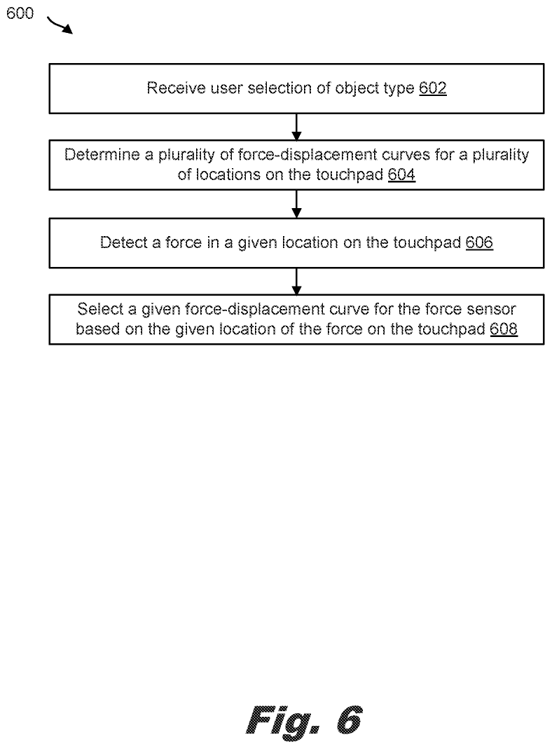

FIG. 6 is a flow diagram illustrating another method 600 for input device calibration, according to an example. The method 600 may be implemented by a controller 110 of an electronic device 102. In this example, the input device is a touchpad.

At 602, the controller 110 receives a user selection of an object type 112. As described above, the controller 110 may determine the object weight 114 from the user-selected object type 112.

At 604, the controller 110 determines a plurality of force-displacement curves for a plurality of locations on the touchpad. This may be accomplished as described in FIG. 3 and FIG. 4. For example, the touchpad may be divided into multiple regions. The controller 110 may instruct the user to place a first object in a first region to obtain a first measured displacement of the touchpad. The controller 110 may instruct the user to place the first object and a second object in the first region to obtain a second measured displacement. The controller 110 may determine a force-displacement curve for the first region using the object weight 114, the first measured displacement, and the second measured displacement. This process may be repeated for the other regions of the touchpad.

The controller 110 may assign a given force-displacement curve to a given region of the touchpad. For example, the controller 110 may assign the first force-displacement curve to the first region, the second force-displacement curve to the second region, and so forth.

At 606, the controller 110 detects a force in a given location on the touchpad. The controller 110 may determine which region of the touchpad in which the location of the force is detected. For example, the controller 110 may determine that the force is located in the first region of the touchpad.

At 608, the controller 110 selects a given force-displacement curve for the force sensor 106 based on the given location of the force on the touchpad. For example, the controller 110 may apply the force-displacement curve corresponding to the region of the touchpad in which the force is located to convert a displacement measured by the force sensor 106 to a force value. In an example, if the force is located in the first region of the touchpad, the controller 110 may select the first force-displacement curve to convert the displacement measured by the force sensor 106 to a force value.

The above specification, examples, and data provide a description of the devices, processes and methods of the disclosure. Because many examples can be made without departing from the spirit and scope of the disclosure, this specification sets forth some of the many possible example approaches and implementations.

What is claimed is:

1. An electronic device, comprising:
an input device comprising:
a force sensor to measure a force applied to the input device; and
a controller to:
receive a user selection of an object type for an object to be placed on a location of the input device;
determine a weight of the object in response to receiving the user selection;
receive a force measurement from the force sensor in response to placement of the object on the input device; and
calibrate the force sensor based on the object weight and the force measurement.

2. The electronic device of claim 1, wherein the controller is to determine the object weight based on the object type.

3. The electronic device of claim 2, wherein the controller is to determine the object weight from an object weight database based on the object type.

4. The electronic device of claim 1, wherein the controller is to generate a user instruction to select the object type.

5. The electronic device of claim 1, wherein the force measurement comprises a displacement of the input device in response to placement of the object on the input device.

6. The electronic device of claim 1, wherein the controller is to generate a user instruction to place the object on a location of the input device in response to receiving the user selection of the object type.

7. The electronic device of claim 1, further comprising an actuator to provide haptic feedback in response to the force applied to the input device exceeding a force threshold, wherein the controller is to calibrate the force threshold based on the object weight and the force measurement.

8. An electronic device, comprising:
a touchpad comprising:
a force sensor to measure displacement of the touchpad in response to a force applied to the touchpad;
a memory to store a weight of an object; and
a controller to:
generate a user instruction to place the object on a location of the touchpad;
receive a measured displacement of the touchpad from the force sensor in response to placement of the object on the touchpad; and
calibrate the force sensor based on the stored weight and the measured displacement.

9. The electronic device of claim 8, wherein the user instruction comprises an instruction for the user to place the object on a corner of the touchpad.

10. The electronic device of claim 8, wherein the controller to calibrate the force sensor comprises the controller to determine a force-displacement curve based on the stored weight for the object and the measured displacement.

11. The electronic device of claim 10, wherein the controller is to store the force-displacement curve in the memory to determine a subsequent force applied to the touchpad.

12. The electronic device of claim 8, wherein the object comprises a coin.

13. The electronic device of claim 12, wherein the coin is local to a region in which the electronic device is used.

14. The electronic device of claim 12, wherein the stored weight comprises a standardized weight for the coin.

15. An electronic device, comprising:
a touchpad comprising:
a force sensor to measure displacement of the touchpad in response to a force applied to the touchpad; and
a controller to:
generate a first user instruction to place a first object on the touchpad;
receive a first measured displacement of the touchpad from the force sensor in response to placement of the first object on the touchpad;
generate a second user instruction to place the first object and a second object on the touchpad;
receive a second measured displacement of the touchpad from the force sensor in response to placement of the first object and the second object on the touchpad; and
determine a force-displacement curve for the force sensor based on the first measured displacement and the second measured displacement.

16. The electronic device of claim 15, wherein the first object and the second object are of a same object type.

17. The electronic device of claim 16, wherein the controller is to determine the force-displacement curve based further on a weight of the object type.

18. The electronic device of claim 15, wherein the force-displacement curve indicates an amount of force applied to the touchpad based on a measured displacement of the touchpad.

19. The electronic device of claim 15, wherein the controller is to:
determine a plurality of force-displacement curves for a plurality of locations on the touchpad.

20. The electronic device of claim 19, wherein the controller is to:
select a given force-displacement curve for the force sensor based on a given location of the force on the touchpad.
